(19) United States
(12) Patent Application Publication
(10) Pub. No.: US 2009/0109248 A1
(43) Pub. Date: Apr. 30, 2009

(54) Display Apparatus Having a Multiplicity of Pixels and Method for Displaying Images

(75) Inventors: Andreas Huber, Maisach (DE); Peter Niedermeier, Munchen (DE); Oskar Schallmoser, Ottobrunn (DE)

Correspondence Address: OSRAM SYLVANIA INC, 100 ENDICOTT STREET, DANVERS, MA, 01923, US

(73) Assignee: Osram Gesellschaft Mit Beschrankter Haftung, Munchen (DE)

(21) Appl. No.: 12/086,473

(22) PCT Filed: Nov. 30, 2006
(86) PCT No.: PCT/EP2006/069102

§ 371 Date: Sep. 29, 2008

(30) Foreign Application Priority Data
Dec. 14, 2005 (DE) 102005059765.3

(51) Int. Cl. G09G 5/02

(52) U.S. Cl. 345/694

(57) ABSTRACT

A display apparatus has a multiplicity of pixels, having an image signal generation apparatus for generating color and brightness values for the multiplicity of pixels, a light modulation apparatus, which is coupled to the image signal generation apparatus, for the purpose of modulating the multiplicity of pixels on the basis of the color and brightness values, and an illumination apparatus for the purpose of backlighting the light modulation apparatus. The illumination apparatus has a drive apparatus for driving a multiplicity of light sources, and the drive apparatus is coupled to the image signal generation apparatus or to the light modulation apparatus such that a predetermined group of light sources, designed to backlight a subarea of the light modulation apparatus, can be driven by the drive apparatus as a function of the brightness values for contrast enhancement purposes.

The invention relates to a display apparatus having a multiplicity of pixels, having an image signal generation apparatus for generating color and brightness values for the multiplicity of pixels, a light modulation apparatus, which is coupled to the image signal generation apparatus, for the purpose of modulating the multiplicity of pixels on the basis of the color and brightness values, and an illumination apparatus for the purpose of backlighting the light modulation apparatus.

Display apparatuses, in particular flat display screens, of the abovementioned type are known in various forms. They are particularly suitable for use as computer monitors or as display screens for particularly flat television sets. Light emitted from a light source is used for backlighting a modulation apparatus having a multiplicity of pixels, generally a liquid crystal display (LCD). By driving the individual pixels of the light modulation apparatus using color and brightness values generated from an image signal generation apparatus, only a proportion of the incoming light passes through the light modulation apparatus, with the result that light and dark or differently colored pixels can be generated which then join together, in the eyes of a viewer, to form an overall image.

In particular in the case of display apparatuses in the consumer electronics sector, a particularly high contrast range is desirable. This is because cinema films often contain scenes having a high contrast range, where contrast is the ratio of the difference between the maximum and minimum brightness to a minimum degree of brightness graduation which can be represented.

For a depiction which is true to reality, it is therefore important to be able to represent firstly very fine brightness graduations and secondly the entire range between full luminous intensity of a white pixel and no luminous intensity, i.e. a black pixel. This occurs, for example, in scenes with very nonuniform lighting, for example when simultaneously representing indoor and outdoor shots or lit and shaded areas.

Conventional display apparatuses often have a contrast ratio of markedly less than 1:1000. The human eye, however, is capable of a resolution within a considerably greater contrast range. For a reproduction of films which is true to reality, display apparatuses having contrast ranges of more than 1:1000 are therefore desirable.

U.S. Pat. No. 6,891,672 B2 has disclosed a display screen having an increased contrast range. Light emitted by a light source is first modulated by a first modulation apparatus and then by a second modulation apparatus. As a result, images which are very contrast-rich can be represented, with the result that, for example, even dark image areas can still be represented in finely graduated fashion in terms of brightness.

One disadvantage of the use of two light modulation apparatuses consists in particular in the high costs involved with the light modulation apparatuses, and these costs considerably influence the costs of a display screen. In addition, the second modulation apparatus and an image signal generation apparatus required for said modulation apparatus require additional energy. Furthermore, the series circuit comprising two light modulation apparatuses absorbs a greater proportion of the incident light, with the result that a particularly powerful light source needs to be used, which for its part requires more energy.

The object of the present invention is to describe a display apparatus of the type mentioned initially which has a particularly high contrast range. In this case, the display apparatus should be cost-effective in terms of production and economical in terms of energy consumption.

The object is achieved by a display apparatus of the type mentioned initially, in the case of which the illumination apparatus has a drive apparatus for the purpose of driving a multiplicity of light sources, and the drive apparatus is coupled to the image signal generation apparatus or to the light modulation apparatus such that a predetermined group of light sources, which is designed to backlight a subarea of the light modulation apparatus, can be driven by the drive apparatus as a function of the brightness values for contrast enhancement purposes.

Owing to the targeted driving of groups of light sources which are designed to backlight subareas of the light modulation apparatus, the illumination of particularly dark image areas can be reduced such that the contrast range of the overall image represented increases. Darkening groups of light sources also brings about an energy saving owing to more efficient utilization of the light.

According to the invention, a high contrast can advantageously be achieved using only one light modulator by the illumination apparatus, i.e. the predetermined group of light sources, being partially dimmed. Owing to the dimming, display areas which are intended to be dark can be darkened more severely, which results in a higher degree of contrast.

In one preferred refinement of the invention, each light source of the multiplicity of light sources can be driven individually by the drive apparatus. In this manner, it is also possible for small image areas to be darkened individually.

A display apparatus according to the present invention advantageously functions in accordance with a method for displaying images on a display apparatus having a multiplicity of pixels having the following steps:

receiving an image signal with color and brightness values for the multiplicity of pixels,

calculating brightness characteristics for a plurality of different predetermined groups of pixels from which an image to be displayed is composed,

modulating the pixels by means of a light modulation apparatus on the basis of the color and brightness values, and

illuminating the different predetermined groups of pixels by means of in each case one light source or a predetermined group of light sources as a function of the brightness characteristic calculated for the respective predetermined group of pixels.

In one advantageous refinement of the method, color and brightness values, which have been corrected on the basis of the received color and brightness values of the image signal taking into account the calculated brightness characteristics, are calculated for the purpose of modulating the predetermined groups of pixels.

Owing to the correction of the color and brightness values used for the light modulation using the calculated brightness characteristics, the weaker backlighting of predetermined groups of pixels can be taken into account in the modulation, with the result that, for example, details in the darkened image areas can be represented particularly well.

Further advantageous details and refinements and developments of the invention are specified in the dependent claims.

Further advantages, advantageous refinements and developments are given in the exemplary embodiment explained in more detail below in conjunction with the drawings, in which:

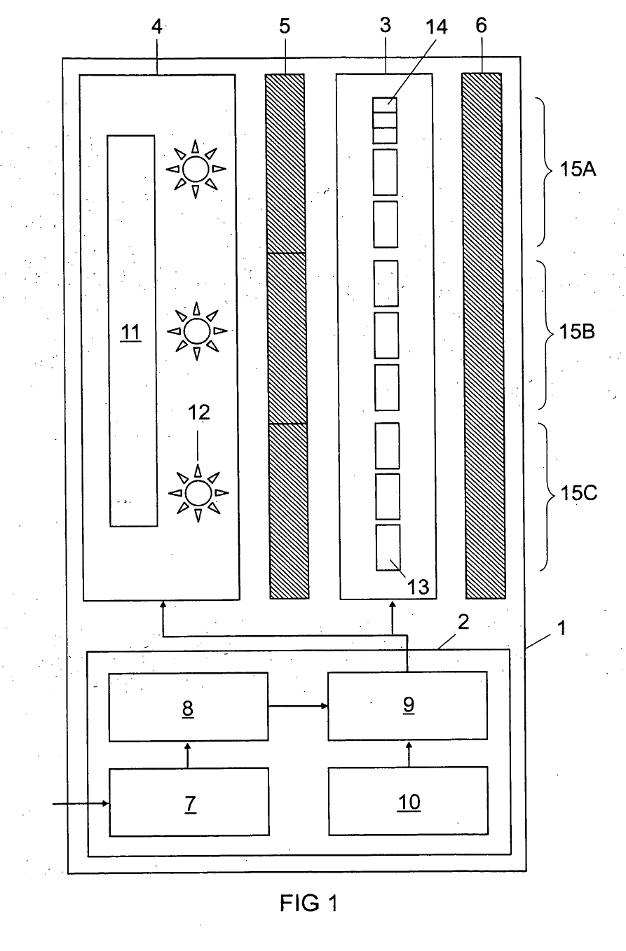

FIG. 1 shows a schematic design of a display screen in accordance with one exemplary embodiment of the invention,

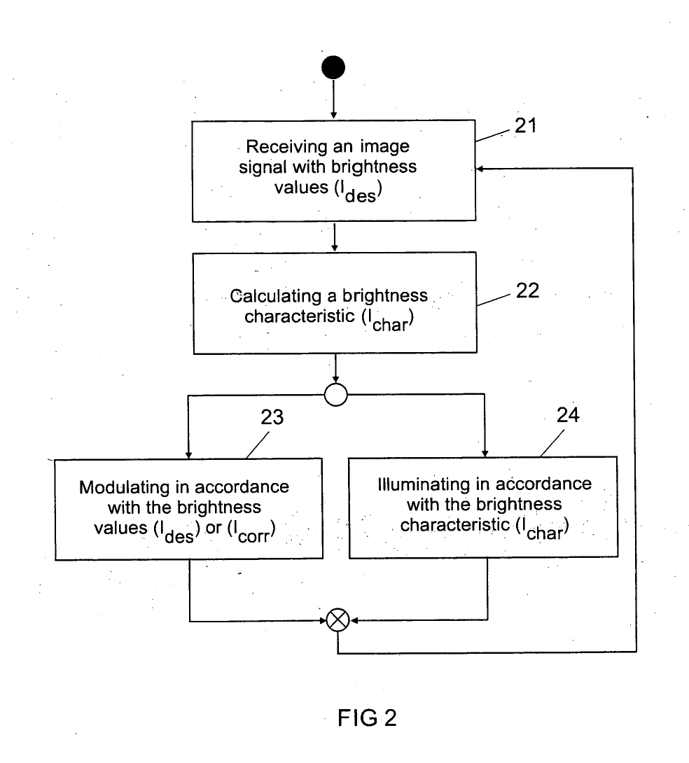

FIG. 2 shows a flowchart for a method for displaying images,

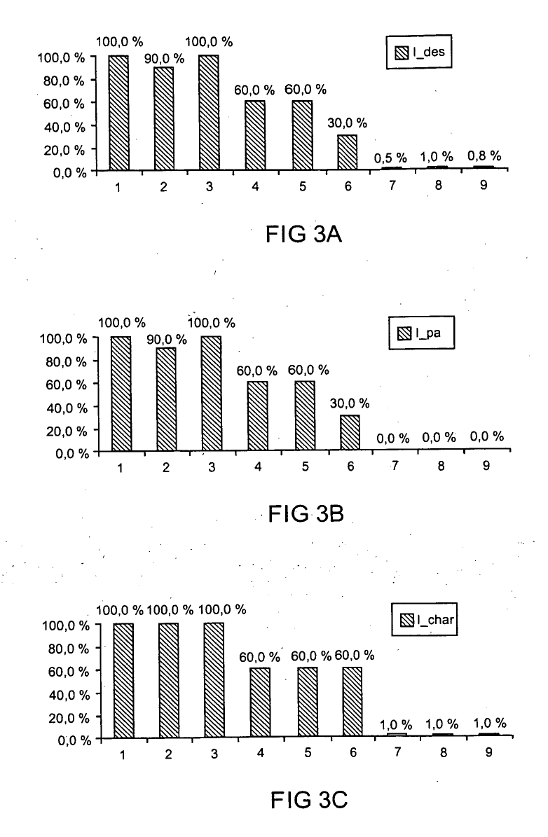

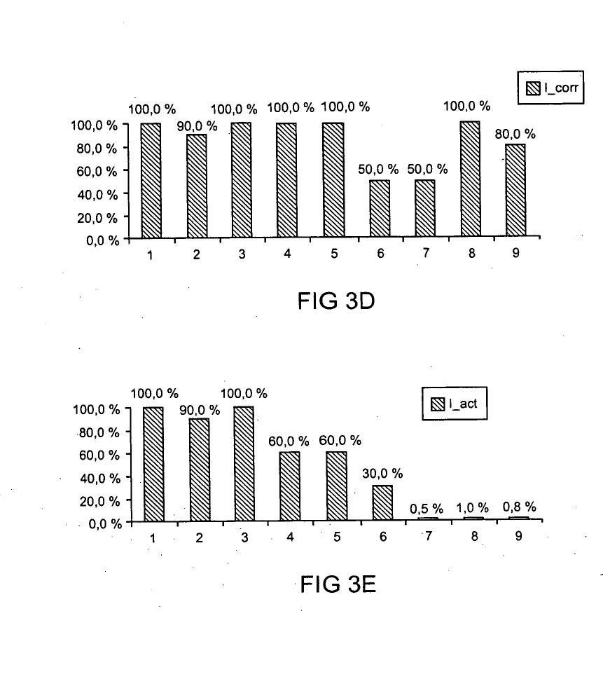

FIG. 3A shows exemplary brightness values to be displayed,

FIG. 3B shows brightness values which are actually displayed according to the prior art,

FIG. 3C shows brightness characteristics for the exemplary brightness values,

FIG. 3D shows corrected brightness values, and

FIG. 3E shows brightness values which are actually displayed in accordance with one refinement of the invention.

FIG. 1 shows, in schematic form, a design for a display apparatus 1, in the exemplary embodiment a flat display screen, in accordance with one refinement of the invention, in cross section.

The display screen 1 has an image signal generation apparatus 2, a light modulation apparatus 3 and an illumination apparatus 4. A diffuser 5 is optionally arranged between the illumination apparatus 4 and the light modulation apparatus 3 and distributes the light from the illumination apparatus 4 for the purpose of backlighting the light modulation apparatus 3. In addition, a matt glass plate 6 is arranged in front of the light modulation apparatus 3, said matt glass plate diffusing the light passing through the light modulation apparatus 3 and at the same time protecting the light modulation apparatus 3 from any contact. The matt glass plate 6 or the diffuser 5 can also serve the purpose of selecting light from a predetermined polarization direction.

The image signal generation apparatus 2 has an image signal decoder 7, an image memory 8, a processing unit 9 and a selection means 10. The illumination apparatus 4 has a drive apparatus 11 and a multiplicity of light sources 12, light-emitting diodes in the exemplary embodiment. The light modulation apparatus 3 comprises a multiplicity of pixels 13, which are suitable for modulating the incident light. In this case, the individual pixels 13 comprise subpixels 14, for example in each case one subpixel 14 for the three primary colors red, green and blue, which only allow the light of the respective primary color to pass through by means of corresponding filters.

The drive apparatus 11 of the illumination apparatus 4 is designed to drive each of the light sources 12 individually such that groups of pixels 15A, 15B and 15C physically associated with the individual light sources 12 can be backlit to differing degrees. The modulator 5 has three areas which are delimited from one another such that light from one light source 12 in each case only backlights one group of pixels 15A, 15B or 15C. Alternatively, illumination of adjacent groups 15A, 15B or 15C can also be taken into account by the processing unit 9.

In practice, display apparatuses 1 naturally have substantially more pixels 13 and light sources 12 used for illuminating them than can be illustrated in FIG. 1. For example, an illumination apparatus 4 having approximately 200 light-emitting diodes as light sources 12 can be used for illuminating a 32″ display screen having several hundred thousand pixels 13. The light sources 12 are in this case arranged, for example, in the form of strips or tiles.

FIG. 2 illustrates a method for displaying images on a display apparatus 1 corresponding to one refinement of the invention.

In the exemplary embodiment, initially, in a first step 21, an image signal, for example a television signal, is received by the image signal decoder 7, which contains the color and brightness values I_{des} contained therein for the pixels 13. The decoded color and brightness values I_{des} are stored in the image memory 8 for further processing purposes.

In a second step 22, brightness characteristics I_{char} are calculated for predetermined groups of pixels 15 using the color and brightness values I_{des} stored in the image memory 8. In the exemplary embodiment illustrated in simplified form in FIG. 1, the display screen 1 has three groups 15A, 15B and 15C of pixels. The upper, central and lower groups 15A, 15B and 15C, respectively, are in this case each associated with one of the light sources 12 and are illuminated by this respective light source 12.

In the exemplary embodiment, in the second step 22 the processing unit 9 identifies that the lower display screen area corresponding to the lower group of pixels 15C represents a particularly dark image area. This information is then stored in the brightness characteristic I_{char} generated for the group 15C.

In a third step 23, the multiplicity of pixels 13 is modulated by the light modulation apparatus 3 taking into account the decoded color and brightness values I_{des}. For example, by applying different voltages to the individual pixels 13 of the light modulation apparatus 3′ the transmission of the pixels 13 or the subpixels 14 for individual colors can be influenced such that an overall picture is produced for a viewer. For this purpose, crystals in a liquid crystal display are generally displaced by producing an electrical field such that their polarization direction changes such that the light of a predetermined polarization is either allowed to pass through or is absorbed.

In one preferred refinement of the invention, the processing unit 9 takes into consideration the previously calculated brightness characteristic I_{char} in the actual present modulation of the pixels 13. For this purpose, color and brightness values I_{corr} which have been corrected from the received color and brightness values I_{des} taking into consideration the calculated brightness characteristic I_{char} are calculated, and are used for the modulation of the pixels 13 of the light modulation apparatus 3.

At the same time, in a fourth step 24, the illumination apparatus 4 is driven by the associated drive apparatus 11 by means of the processing apparatus 9 such that the illumination of the individual groups of pixels 15A, 15B and 15C corresponds to the previously determined brightness characteristics I_{char}. For this purpose, in the example given, in which the lower image area of the display screen 1 contains a particularly dark image section, the group of pixels 15C can be darkened by the associated lower light source 12 being darkened.

Depending on an image refresh rate of the image to be displayed, the described process is repeated after a predetermined period of time, with the result that both the pixels 13 of the light modulation apparatus 3 and the light sources 12 of the illumination apparatus 4 are continuously driven in a manner corresponding to the requirements of a respectively present image signal.

FIG. 3A shows brightness values I_{des} for each of the pixels 13 which are intended to be represented by the display screen 1. For reasons of simplicity, consideration is only given to brightness values I_{des} and not to color information in FIG. 3A and in the subsequent figures. In practice, the calculation described below is carried out for each individual one of the colors represented, for example red, green and blue.

In the example illustrated, the three first pixels 13 of the first group of pixels 15A are intended to represent a very bright image area. The next three pixels 13 of the second group of pixels 15B represent an image area having medium brightness. The last three pixels 13 of the last group 15C represent a very dark image area. In this case, in each case one brightness value I_{des} for each of the pixels 13 to be represented is given as a percentage in FIG. 3A.

FIG. 3B shows the actually displayed brightness intensity Iₚₐ of a display screen 1 according to the prior art with an exemplary contrast ratio of 1:10. In this example, a light modulation apparatus 3 can represent only ten different brightness stages.

The brightness values illustrated in FIG. 3A can only be represented correctly in the areas of the first and second groups of pixels 15A and 15B. The very low brightness in the area of the third group of pixels 15C no longer permits a representation which is true to the signals and is therefore true to reality. In FIG. 3B, this image area is completely darkened, with the result that details contained therein are no longer represented.

FIG. 3C represents brightness characteristics I_{char} determined in accordance with one refinement of the invention. In the example illustrated, the respective maximum value for a group of pixels 15A, 15B or 15C is used as the brightness characteristic.

Correspondingly, in the example the first light source 12 of the first group 15A is driven at 100 percent of the possible power, the second light source 12 is driven at 60 percent of the possible power, and the third light source 12 is only driven at one percent of the possible power. Since the luminous intensity of light-emitting diodes used in the exemplary embodiment as the light source 12 rises essentially linearly with an operating current, the individual light sources 12 can be driven, for example, by means of current control as required.

FIG. 3D shows corrected brightness values I_{corr} for driving the modulation apparatus 3, which are calculated, for example, by means of the processing unit 9. In the exemplary embodiment, the corrected brightness values I_{corr} result from the division of the brightness values I_{des} to be displayed from FIG. 3A by the calculated brightness characteristic I_{char} from FIG. 3B.

FIG. 3E illustrates the brightness values I_{act} perceived by a viewer on the matt glass plate 6. Since the brightness values I_{act} visible on the matt glass plate 6 essentially result from the multiplication of the illumination intensity corresponding to the brightness characteristic I_{char} illustrated in FIG. 3C by the corrected brightness values I_{corr} from FIG. 3D used for the modulation, the brightness values I_{act} illustrated in accordance with the exemplary embodiment for each individual pixel 13 correspond precisely to the brightness values I_{des} contained in the image signal. A reproduction of the image signal which is true to nature is therefore possible.

According to one further refinement of the invention, individual image areas can also be darkened or lightened in a targeted manner with the aid of the selection means 10. For example, it is possible to brighten or darken an image area with a group 15 of pixels 13 by means of an input by a user, for example in order to make it easier to read, for example, subtitles displayed in a lower image area or in order to remove the subtitles by means of darkening.

If, for example, white subtitles are displayed on a black background in a lower image area of a cinema film, in which background there is no image information, the display of the disruptive subtitles on the matt glass plate 6 can be prevented by dimming or switching off the associated light source 12 of the group of pixels 15C.

Although in the exemplary embodiment illustrated a display screen 1 is used for displaying the image signal, the method according to the invention can of course also be used for other display methods and apparatuses, for example in projection or rear projection, for example using a video projector or so called data beamers. In this case, it is also possible to use a reflecting modulation apparatus 9, such as a matrix of controllable mirrors (digital mirror device—DMD), in place of a filtering light modulation apparatus 3, such as a liquid crystal display.

Equally, other, in particular small-area, light sources 12 can also be used in place of the light-emitting diodes used in the exemplary embodiment, these light sources 12 being suitable for illuminating individual groups of pixels 15. In this case, it is advantageous if the light sources 12 are designed such that their luminous area or emission characteristic can be physically associated with the pixels 13 to be backlit. For example, organic, surface-emitting light-emitting diodes (OLEDs) can also be used with a luminous area of less than 5 mm².

### LIST OF REFERENCE SYMBOLS

1 Display screen

2 Image signal generation apparatus

3 Light modulation apparatus

4 Illumination apparatus

5 Diffuser

6 Matt glass plate

7 Image signal decoder

8 Image memory

9 Processing unit

10 Selection means

11 Drive apparatus

12 Light source

13 Pixel

14 Subpixel

15 Group of pixels

21 to 24 Method steps

I_{des} Brightness value to be displayed

Iₚₐ Displayed brightness value (prior art)

I_{char} Brightness characteristic

I_{corr} Corrected brightness value

I_{act} Displayed brightness value (according to the invention)

1. A display apparatus (1) having a multiplicity of pixels (13), having:
an image signal generation apparatus (2) for generating color and brightness values (I_{des}) for the multiplicity of pixels (13),
a light modulation apparatus (3), which is coupled to the image signal generation apparatus (2), for the purpose of modulating the multiplicity of pixels (13) on the basis of the color and brightness values (I_{des}), and
an illumination apparatus (4) for the purpose of backlighting the light modulation apparatus (3),
characterized in that
the illumination apparatus (4) has a drive apparatus (11) for the purpose of driving a multiplicity of light sources (12), in particular light-emitting diodes, and
the drive apparatus (11) is coupled to the image signal generation apparatus (2) or to the light modulation apparatus (3) such that a predetermined group of light sources, which is designed to backlight a subarea of the light modulation apparatus (3), can be driven by the drive apparatus (11) as a function of the brightness values (I_{des}) for contrast enhancement purposes.

2. The display apparatus (1) as claimed in claim 1, characterized in that
a diffuser (5) is arranged between the illumination apparatus (4) and the light modulation apparatus (3) and distributes light from the predetermined group of light sources (12) amongst a predetermined group (15) of pixels (13) of the subarea of the light modulation apparatus (3), and
the image signal generation apparatus (2) calculates a brightness characteristic (I_{char}) of the group of pixels (15) such that the group of light sources can be driven as required by the drive apparatus (11).

3. The display apparatus (1) as claimed in claim 1, characterized in that
each light source (12) of the multiplicity of light sources (12) can be driven individually by the drive apparatus (11).

4. The display apparatus (1) as claimed in claim 1, characterized in that
the light sources (12) are surface-emitting light sources, in particular organic light-emitting diodes.

5. A method for displaying images on a display apparatus (1) having a multiplicity of pixels (13) having the following steps:
receiving an image signal with color and brightness values (I_{des}) for the multiplicity of pixels (13),
calculating brightness characteristics (I_{char}) for a plurality of different predetermined groups (15) of pixels (13) from which an image to be displayed is composed,
modulating the pixels (13) by means of a light modulation apparatus (3) on the basis of the color and brightness values (I_{des}), and
illuminating the different predetermined groups of pixels (15) by means of in each case one light source (12) or a predetermined group of light sources (12) as a function of the brightness characteristic (I_{char}) calculated for the respective predetermined group of pixels (15).

6. The method as claimed in claim 5, characterized in that
color and brightness values (I_{corr}), which have been corrected on the basis of the received color and brightness values (I_{des}) of the image signal taking into account the calculated brightness characteristics (I_{char}), are calculated for the purpose of modulating the predetermined group of pixels (13).

7. The method as claimed in claim 5, characterized in that
the calculation of the brightness characteristics (I_{char}) is carried out on the basis of the minimum, the mean or the maximum of the brightness values (I_{des}) associated with the predetermined group of pixels (15).

8. The display apparatus (1) as claimed in claim 2, characterized in that
each light source (12) of the multiplicity of light sources (12) can be driven individually by the drive apparatus (11).

9. The display apparatus (1) as claimed in claim 2, characterized in that
the light sources (12) are surface-emitting light sources, in particular organic light-emitting diodes.

10. The display apparatus (1) as claimed in claim 3, characterized in that
the light sources (12) are surface-emitting light sources, in particular organic light-emitting diodes.

11. The method as claimed in claim 6, characterized in that
the calculation of the brightness characteristics (I_{char}) is carried out on the basis of the minimum, the mean or the maximum of the brightness values (I_{des}) associated with the predetermined group of pixels (15).
